(19) United States
(12) Patent Application Publication
(10) Pub. No.: US 2009/0190980 A1
(43) Pub. Date: Jul. 30, 2009

(54) Developing Method, Image Forming Method and Image Forming Apparatus

(75) Inventors: Shinichi Tanaka, Shiojiri-shi (JP); Ken Ikuma, Suwa-shi (JP)

Correspondence Address: HOGAN & HARTSON L.L.P., 1999 AVENUE OF THE STARS, SUITE 1400, LOS ANGELES, CA, 90067, US

(73) Assignee: Seiko Epson Corporation, Tokyo (JP)

(21) Appl. No.: 12/360,013

(22) Filed: Jan. 26, 2009

(30) Foreign Application Priority Data
Jan. 28, 2008 (JP) 2008-016080
Oct. 6, 2008 (JP) 2008-259488

(51) Int. Cl. G03G 15/00

(52) U.S. Cl. 399/397

(57) ABSTRACT

A transfer material separating device comprises a transfer material separating gas current section for separating a transfer material being moved with a transfer material moving member from the transfer material moving member by blowing gas to the transfer material and a control section for controlling the current of gas being blown from the transfer material separating gas current section to the transfer material, the transfer material separating gas current section including a gas current generating section for generating a gas current, a first gas current duct arranged at a position corresponding to a central part of the transfer material in the direction orthogonal or substantially orthogonal relative to the transfer material conveying direction and having a first gas blowing port connected to the gas current generating section, a second gas current duct arranged adjacent to the first gas current duct in the direction orthogonal or substantially orthogonal relative to the transfer material conveying direction and having a second gas blowing port connected to the gas current generating section and a third gas current duct arranged adjacent to the first gas current duct at the side opposite to the second gas current in the direction orthogonal or substantially orthogonal relative to the transfer material conveying direction and having a third gas blowing port connected to the gas current generating section.

### CROSS REFERENCE TO RELATED APPLICATIONS

This application is based upon and claims the benefit of priority from prior Japanese Patent Application No. 2008-016080, filed Jan. 28, 2008 and Japanese patent Application No. 2008-259488, filed Oct. 6, 2008, the entire contents of which are incorporated herein by reference.

### BACKGROUND

1. Technical Field

The present invention generally relates to the technological field of electrophotographic type image forming apparatus adapted to use liquid developer (liquid toner) such as copying machines, facsimile machines and printers. More particularly, the present invention relates to a transfer member separating device for separating a transfer material to which a liquid developer image is transferred from a transfer material moving member and a transfer device for transferring a liquid developer image onto a transfer material that are to be used in such an image forming apparatus.

2. Related Art

Generally, in an image forming apparatus adapted to use liquid developer (liquid toner), a liquid developer image is transferred onto a transfer material as the transfer material is pressed against the transfer medium of a transfer device and driven to move with the transfer medium. Additionally, a liquid developer image is fixed to a transfer material onto which a liquid developer image is transferred as the transfer material is pressed against the fixing member of a fixing device.

With an arrangement as described above, more specifically, the transfer surface bearing a liquid developer image of the transfer material is pressed against a transfer material moving member, which may be a transfer medium or a fixing member. As the transfer surface of the transfer material is pressed against the transfer material moving member, the transfer material can easily adhere to the transfer material moving member because of the properties of the liquid developer that are specific to the developer. Then, it is difficult to separate the transfer material onto which a liquid developer image is transferred from the transfer material moving member.

In view of this problem, Japanese Patent Publication No. 3,128,067 (to be referred to as Document 1 hereinafter) proposes an image forming apparatus equipped with a transfer material separating device designed to forcibly separate the front edge of a transfer material from the transfer material moving member by blowing air to the front edge of the transfer material moving with the transfer material moving member. With a transfer material separating device described in the Document 1, the front end part of the transfer material is separated from the transfer material moving member as blown air penetrates between the front edge of the transfer material and the transfer material moving member.

However, a transfer material separating device described in Document 1 simply blows air to the front edge of a transfer material during an image forming operation and hence it is difficult to reliably and efficiently separate a transfer material.

### SUMMARY

An object of the present invention is to provide a transfer material separating device, a transfer device and an image forming apparatus that can efficiently and reliably separate a transfer material by means of gas.

A transfer material separating device, a transfer device and an image forming apparatus according to the present invention are designed to generate a gas current by means of a transfer material separating gas current section in order to achieve the above object. Then, gas is blown to the front edge of the transfer material moving with the transfer material moving member that is a transfer medium or a developer image carrier such as a latent image carrier. Thus, the transfer material can be separated from the transfer material moving member by blown air. Then, as a result, the transfer material is prevented from moving further with the transfer material moving member and the transfer material can be reliably moved toward the next conveyance station.

Particularly, a gas current control valve is arranged near the gas blowing port of the gas current duct of the transfer member separating gas current section. Then, gas can be blown to the front edge of the transfer material stably at a desired flow rate in the initial stages of a gas blowing operation by means of the gas current control valve. As a result, the front edge of the transfer material can be reliably peeled off by blown air.

Additionally, the operating conditions of the transfer material separating gas current section such as the gas flow rate at the time of blowing gas, the duration of the gas blowing operation and the timing of starting the gas blowing operation are defined according to the moving conditions of the transfer material that is moving with the transfer material moving member including the level of difficulty of separation specific to the type of the transfer material, the white margin (the non-image part) at the front edge of the transfer material and the moving speed of the transfer material so that the operation of the transfer material separating gas current section can be optimized and the transfer material can be further efficiently and appropriately separated. Particularly, if the transfer material is not an easily separable material, it can be reliably separated from the transfer material moving member with the above-described arrangement.

Still additionally, a first gas current duct is arranged at a position corresponding to a central part of the transfer material as viewed in a direction perpendicular or substantially perpendicular to the transfer material conveying direction and a second gas current duct is arranged adjacent to the first gas current duct in a direction perpendicular or substantially perpendicular to the transfer material conveying direction. Furthermore, a third gas current duct is arranged adjacent to the first gas current duct at the side opposite to the second gas current duct in a direction perpendicular or substantially perpendicular to the transfer material conveying direction. Gas is blown from the first gas current duct at a flow rate higher than the flow rate of gas blown from the second and third gas current ducts. As a result, the transfer material can be separated efficiently from the transfer material moving member in response to the moving conditions of the transfer material that is moving with the transfer material moving member including the type of the transfer material, the white margin at the front edge of the transfer material and the moving speed of the transfer material.

Finally, since the operation of the transfer material separating gas current section is optimized, it can be operated economically to save energy. The transfer material separating gas current section may not be driven when no transfer material is conveyed to the transfer section. Thus, as a result, the transfer material separating gas current section can be operated further economically to remarkably save energy.

### BRIEF DESCRIPTION OF THE DRAWINGS

The invention will be described with reference to the accompanying drawings, wherein like members reference like elements.

FIG. 1 is a schematic illustration of part of an embodiment of image forming apparatus equipped with a transfer material separating device according to the present invention, showing a first exemplar arrangement;

FIG. 2 is an enlarged schematic illustration of part II in FIG. 1, illustrating the parameters for defining operating conditions of the transfer material separating gas current device;

FIG. 3 is a timing chart illustrating the sequence of timings of the air blowing operation of the transfer material separating gas current device of the first exemplar arrangement of FIG. 1;

FIG. 4A is a schematic perspective view of a transfer material separating device, showing a second exemplar arrangement, according to the embodiment of the present invention;

FIG. 4B is a schematic perspective view of a transfer material separating device, showing a third exemplar arrangement, according to the embodiment of the present invention;

FIG. 5 is an enlarged schematic illustration of part of a transfer material separating device similar to FIG. 2, showing a fourth exemplar arrangement, of the embodiment of the present invention;

FIG. 6 is a timing chart illustrating the sequence of timings of the air blowing operation of the transfer material separating gas current device of the fourth exemplar arrangement;

FIG. 7 is an enlarged schematic illustration of part of a transfer material separating device similar to FIG. 5, showing a fifth exemplar arrangement, according to the embodiment of the present invention;

FIG. 8 is an enlarged schematic partial view of part of a transfer material separating device where an air control valve is provided; and

FIG. 9 is a timing chart illustrating the sequence of timings of the air blowing operation of the transfer material separating gas current device of the fifth exemplar arrangement.

### DESCRIPTION OF THE EXEMPLARY EMBODIMENTS

Now, preferred embodiments of the present invention will be described in greater detail by referring to the accompanying drawings.

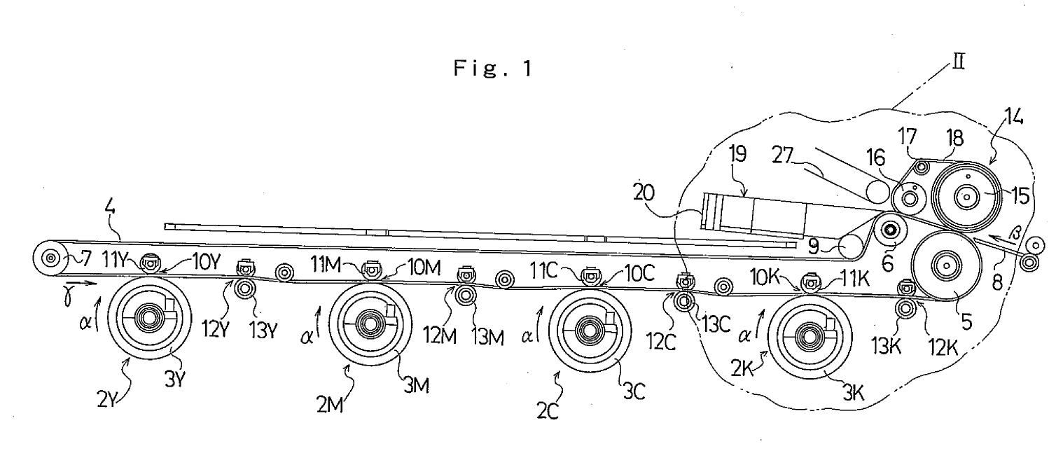

FIG. 1 is a schematic illustration of part of an embodiment of image forming apparatus equipped with a transfer material separating device according to the present invention, showing a first exemplar arrangement.

Referring to FIG. 1, the image forming apparatus 1 of the first exemplar arrangement has image forming units 2Y, 2M, 2C and 2K arranged in tandem so as to use liquid developers of respective colors of yellow (Y), magenta (M), cyan (C) and black (K). Note that the image forming units 2Y, 2M, 2C and 2K are respectively a yellow image forming unit, a magenta image forming unit, a cyan image forming unit and a black image forming unit. The reference symbols of other component members are also suffixed by Y, M, C and K to indicate the related respective colors.

The image forming units 2Y, 2M, 2C and 2K have respective photosensitive bodies 3Y, 3M, 3C and 3K that are latent image carriers. The photosensitive bodies 3Y, 3M, 3C and 3K illustrated in FIG. 1 are photosensitive drums, although the photosensitive bodies 3Y, 3M, 3C and 3K may alternatively be formed by using endless bents.

All the photosensitive bodies 3Y, 3M, 3C and 3K are adapted to be driven to rotate clockwise in FIG. 1 as indicated by arrow α. Although not shown, the image forming units 2Y, 2M, 2C and 2K are provided respectively with charging members, exposure devices, liquid developing devices, photosensitive body squeezing devices, charge eliminating devices and photosensitive body cleaning devices that are arranged around the photosensitive bodies 3Y, 3M, 3C and 3K as in any known image forming apparatus designed to use liquid developers. The charging members, the exposure devices, the liquid developing devices, the photosensitive body squeezing devices, the charge eliminating devices and the photosensitive body cleaning devices are arranged in the mentioned order in the sense of rotation of the photosensitive bodies 3Y, 3M, 3C and 3K. Electrostatic latent images of the corresponding colors are respectively formed on the photosensitive bodies 3Y, 3M, 3C and 3K and then toner images are produced as the electrostatic latent images are developed by liquid developers of the corresponding colors.

As shown in FIG. 1, the image forming apparatus 1 also has an endless intermediate transfer belt 4 that is a transfer medium. The transfer medium may be alternatively formed by using a transfer roller, although the transfer medium is an intermediate transfer belt 4 in the following description.

The intermediate transfer belt 4 is wound around a belt driving roller 5, to which drive force is transmitted from a motor (not shown), and a pair of driven rollers 6 and 7. More specifically, the belt driving roller 5 and the driven roller 6 are arranged adjacently relative to each other with a predetermined gap separating them along the transfer material moving direction β of the transfer member 8, which may typically be a sheet of paper, being conveyed toward a secondary transfer device 14, which will be described in greater detail hereinafter. The belt driving roller 5 and the driven roller 7 are separated from each other in the direction of the tandem arrangement of the photosensitive bodies 3Y, 3M, 3C and 3K. The intermediate transfer belt 4 is subjected to a predetermined level of tension that is applied by a tension roller 9. The intermediate transfer belt 4 is arranged so as to be driven by the belt driving roller 5 to rotate counterclockwise in FIG. 1 as indicated by arrow γ.

The image forming units 2Y, 2M, 2C and 2K are arranged in the order of the colors of Y, M, C and K from the upstream side in the sense of rotation γ (in FIG. 1 [left side]) of the intermediate transfer belt 4 in the image forming apparatus 1 of the first exemplar arrangement, although the order of arrangement of the colors of Y, M, C and K may be selected differently and appropriately.

Primary transfer devices 10Y, 10M, 10C and 10K are arranged respectively around the photosensitive bodies 3Y, 3M, 3C and 3K. The primary transfer devices 10Y, 10M, 10C and 10K are arranged respectively between the photosensitive body squeezing devices and the charge eliminating devices of the different colors, which are not shown. The primary transfer devices 10Y, 10M, 10C and 10K are respectively provided with primary transfer backup rollers 11Y, 11M, 11C and 11K. The intermediate transfer belt 4 is pressed against the photosensitive bodies 3Y, 3M, 3C and 3K respectively by means of the backup rollers 11Y, 11M, 11C and 11K.

As an electric charge showing the polarity opposite to the polarity of the electric charge of toner particles is applied to each of the backup rollers 11Y, 11M, 11C and 11K, the toner image on the corresponding one of the photosensitive bodies 3Y, 3M, 3C and 3K is transferred onto the intermediate transfer belt 4. Note that the yellow (Y) toner image is transferred onto the intermediate transfer belt 4 first and the magenta (M) toner image is then transferred onto the intermediate transfer belt 4 so as to be superposed on the yellow (Y) toner image. Subsequently, the cyan (C) toner image and the black (K) toner images are sequentially transferred onto the intermediate transfer belt 4 so as to be superposed on the already superposed toner image on the intermediate transfer belt 4 to form a full color toner image on the intermediate transfer belt 4.

Intermediate transfer belt squeezing devices 12Y, 12M, 12C and 12K are arranged respectively near the primary transfer devices 10Y, 10M, 10C and 10K at positions downstream relative to the primary transfer devices 10Y, 10M, 10C and 10K in the sense of rotation γ of the intermediate transfer belt 4. The intermediate transfer belt squeezing rollers 12Y, 12M, 12C and 12K are provided respectively with intermediate transfer belt squeezing rollers 13Y, 13M, 13C and 13K. The intermediate transfer belt squeezing rollers 13Y, 13M, 13C and 13K are arranged respectively to collect carrier liquids of the corresponding colors on the intermediate transfer belt 4.

Additionally, the secondary transfer device 14 is arranged adjacently relative to the intermediate transfer belt 4 at the side of the belt driving roller 5. The secondary transfer device 14 includes a pair of rollers 15, 16 arranged along the transfer material moving direction β with a predetermined gap separating them from each other, a roller 17 arranged in a direction subsequently orthogonal relative to the transfer material moving direction β relative to the roller 16 and a transfer belt 18 wound around the three rollers 15, 16 and 17. The upstream side roller 15 in the sense of the transfer material moving direction β is arranged opposite to the belt driving roller 5 and presses the transfer belt 18 against the intermediate transfer belt 4 wound around the belt driving roller 5. The downstream side roller 16 in the sense of the transfer material moving direction β is arranged opposite to the driven roller 6 and presses the transfer belt 18 against the intermediate transfer belt 4 wound around the driven roller 6. Thus, the toner image (liquid developer image) on the intermediate transfer belt 4 is transferred onto a transfer material 8 as the transfer material 8 is pinched at the transfer nip section between the part of the transfer belt 18 extending between the two rollers 15 and 16 and the part of the intermediate transfer belt 4 extending between the belt driving roller 5 and the driven roller 6 and moves in the transfer material moving direction β. Therefore, the intermediate transfer belt 4 operates for the transfer material moving members and the liquid developer image carriers of the present invention.

Although now shown, the image forming apparatus 1 of the first exemplar arrangement has a transfer material container for containing the transfer material 8, which may be typically sheets of paper, that is arranged upstream relative to the secondary transfer device 14 in the transfer material conveying direction and a registration roller pair for conveying and supplying a transfer material 8 from the transfer material container to the secondary transfer device 14 like known ordinary image forming apparatus. Similarly, the image forming apparatus 1 also has a fixing device and a transfer material delivery tray arranged downstream relative to the secondary transfer device 14 in the transfer material conveying direction. Note that the transfer material belt conveyor device 27 for conveying a transfer material 8 from the secondary transfer device 14 to the fixing device is partly illustrated in FIG. 1.

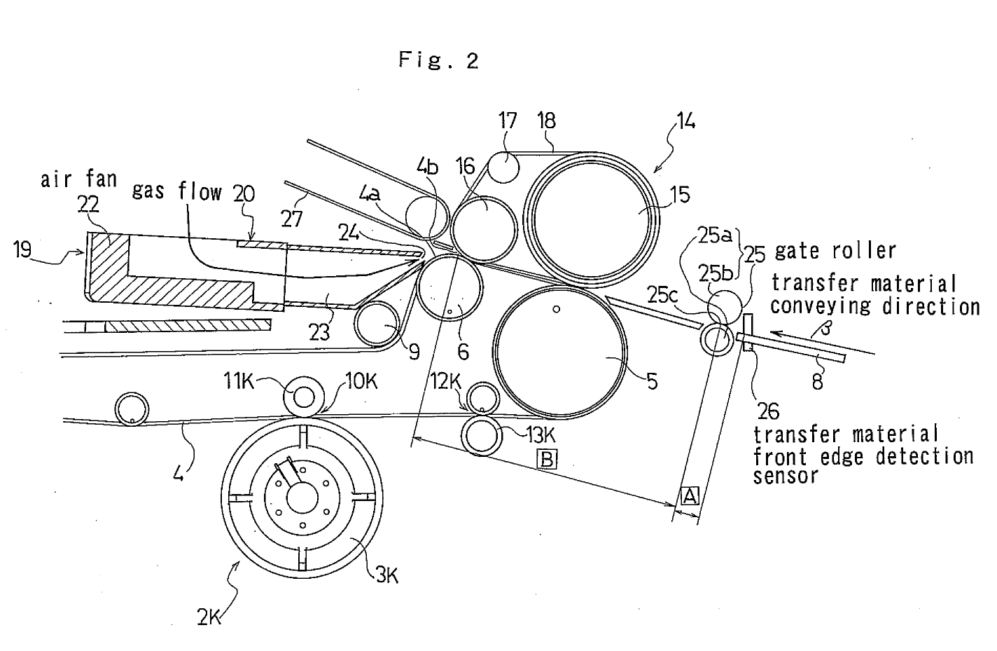

As shown in FIG. 1, the secondary transfer device 14 includes a transfer material separating device 19 arranged adjacent to the downstream end of the transfer nip section. As shown in FIG. 2, the transfer material separating device 19 has a transfer material separating air device (which corresponds to a transfer material separating gas current section in the appended claims of the present invention) for blowing air to the separating position 4a where the transfer material 8 is separated from the intermediate transfer belt 4. A gas blowing device for blowing gas other than air may alternatively be used instead of the transfer material separating air device 20. However, a transfer material separating air device 20 for blowing air is employed in this embodiment in the following description.

As FIG. 2 shows in detail, the transfer material separating air device 20 includes an air fan 22 that is a gas current generating section for sucking air in the apparatus main body and generating a gas current, an air duct 23 that is a gas current duct through which the gas current generated by the air fan 22 flows and an air blowing port 24 that is a gas current blowing port arranged at the front edge of the air duct 23. The air blowing port 24 is open toward the separating position 4a of the transfer material 8 and the intermediate transfer belt 4. Therefore, air or a gas current is blown from the air blowing port 24 toward the separating position 4a (note that the direction in which air is blown by the transfer material separating air device 20 agrees or subsequently agrees with the tangential direction of the curved part of the intermediate transfer belt 4 wound around the driven roller 6 at the separating position 4a of the circular arc section.) The air fan 22 of the transfer material separating device 19 is operated under the control of the control section of the image forming apparatus 1.

Additionally, as shown in FIG. 2, a gate roller pair 25 including rollers 25a and 25b is arranged upstream and adjacently relative to the secondary transfer device 14 in the transfer material moving direction β. Furthermore, a transfer material front edge detection sensor 26 (pre-transfer transfer material front edge detection sensor) is arranged upstream and adjacently relative to the gate roller pair 25 in the transfer material moving direction β. The transfer material front edge detection sensor 26 may be formed by using a known optical sensor or a known mechanical sensor.

The distance A between the front edge detecting position where the transfer material front edge detection sensor 26 detects the front edge of a transfer material and the center position 25c of the nip section between the rollers 25a and 25b of the gate roller pair 25 is defined to be equal to A. The distance B between the center position 25c of the nip section between the rollers 25a and 25b of the gate roller pair 25 and a predetermined electrode position 4b between the downstream end of the transfer nip section of the secondary transfer device 14 and the separating position 4a is defined to be equal to B. The distance B is influenced by the length of the transfer nip section between the intermediate transfer belt 4 and the transfer belt 18. The transfer material separating air device 20 is adapted to blow air from the air blowing port 24 toward the separating position 4a.

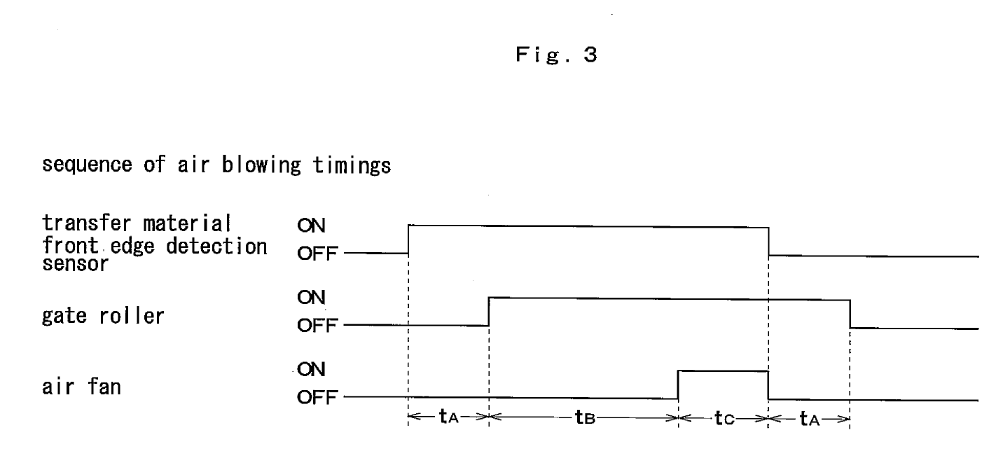

FIG. 3 is a timing chart illustrating the sequence of timings of the air blowing operation of the transfer material separating gas current device.

As shown in FIG. 3, as the transfer material 8 moves toward the secondary transfer device 14 at a speed defined in the image forming apparatus 1 in advance while the image forming apparatus is operating for forming an image, the transfer material front edge detection sensor 26 detects the front edge of the transfer material 8 and becomes on. As a predefined time period t_{A} (sec; distance A/transfer material moving speed) passes from the time when the transfer material front edge detection sensor 26 becomes on, the front edge of the transfer material 8 gets to the center position 25c of the nip section between the rollers 25a and 25b of the gate roller pair 25 and, at the same time, a gate roller pair drive signal is output from the control section. As a result, the gate roller pair 25 is turned on to start rotating. Then, the on of the gate roller pair 25 triggers the process of conveying the front edge of the transfer material 8 for a secondary transfer so that the transfer material 8 starts to be conveyed from the front edge thereof at the timing of bringing the full color toner image that has been transferred onto the intermediate transfer belt 4 by a primary transfer to the transfer position of the secondary transfer device 14.

As a predefined time period t_{B} (sec; distance B/transfer material moving speed) passes from the timing of triggering the process of conveying the front edge of the transfer material 8 by the gate roller pair 25, the front edge of the transfer material 8 passes the downstream end of the transfer nip section of the secondary transfer device 14 and gets to the above-described predetermined position 4b. Then, the air fan 22 is driven to operate and the transfer material separating air device 20 starts blowing air form the air blowing port 24 toward the separating position 4a. As a result, air penetrates between the front edge of the transfer material 8 and the intermediate transfer belt 4 to start separating the front edge of the transfer material 8 from the intermediate transfer belt 4. When air is blown to the separating position 4a for a predefined time tc (sec), air fan 22 is stopped to end the operation of blowing air of the transfer material separating air device 20. The front edge of the transfer material 8 separated from the intermediate transfer belt 4 is then moved toward the transfer material belt conveyor device 27 for conveying the transfer material 8 to the fixing device.

Meanwhile, with the image forming apparatus 1 of the first exemplar arrangement, the operating conditions of the transfer material separating air device 20 such as the air flow rate at the time of blowing air, the time period tc (sec) of the air blowing operation and the timing of starting the air blowing operation are defined according to the transfer material delivery conditions (which correspond to the moving conditions in the appended claims of the present invention) of the transfer material 8 that is being delivered from the transfer nip section including the level of difficulty of separation due to the type of the transfer material 8, the level of difficulty of separation due to the white margin (the front non-image part) at the front edge of the transfer material and the level of difficulty of separation due the moving speed of the transfer material 8. The types of transfer material 8 showing a high level of difficulty of separation, the types of transfer material 8 showing a low level of difficulty of separation, the reference value for the margin at the front edge of the transfer material and the reference value of the moving speed of the transfer material 8 are stored in advance in the memory of the control section of the image forming apparatus 1.

Thus, when the control section of the image forming apparatus 1 determines that the type of the transfer material 8 selected by the user shows a high level of difficulty of separation from the intermediate transfer belt 4, the number of revolutions per unit time of the air fan 22 is raised. Then, as a result, a strong wind blows to the separating position 4a and hence to the front edge of the transfer material 8. Additionally, after the front edge of the transfer material 8 is separated from the intermediate transfer belt 4, the number of revolutions per unit time of the air fan 22 is lowered from the level before the start of the operation of separating the transfer material 8 from the intermediate transfer belt 4 so that a weak wind blows to the front edge of the transfer material 8 for a predetermined time period. In this way, the air flow rate is reduced from that of a strong wind before the separation of the transfer material to that of a weak wind after the separation of the transfer material and the weak wind is made to blow continuously for a predetermined time period after the separation of the front edge of the transfer material. Thus, a relatively long time period is selected for the time period tc (sec) of the air blowing operation.

On the other hand, when the control section of the image forming apparatus determines that the type of the transfer material 8 shows a low level of difficulty of separation from the intermediate transfer belt 4, a strong wind is also made to blow to the front edge of the transfer material 8. However, the time period during which the strong wind is made to blow to the front edge of the transfer material is made shorter than the time period selected for the type of transfer material 8 showing a high level of difficulty of separation and the air blowing operation of the air fan 22 is stopped after the separation of the front edge of the transfer material. Thus, a relatively short time period is selected for the time period tc (sec) of the air blowing operation if compared with a transfer material 8 showing a high level of difficulty of separation.

Additionally, as the control section determines that the moving speed of the transfer material 8 is higher than the reference value, the time period tB (sec) from the time when the start of conveying the front edge of the transfer material is triggered to the time when the front edge of the transfer material gets to the separating position 4a where it is separated from the intermediate transfer belt 4 is made short. Then, therefore, the timing of starting the air blowing operation is made earlier as a function of the moving speed so that the front edge of the transfer material 8 that is moving fast and getting early to the separating position 4a is reliably separated from the intermediate transfer belt 4.

Meanwhile, as the control section determines that the front edge margin of the transfer material is greater than the reference value, it means that the front edge area of the transfer material 8 bears only a small quantity of toner so that the front edge can be separated from the intermediate transfer belt 4 with ease. Then, the number of revolutions per unit time of the air fan 22 is made lower than the reference value so that the front edge of the transfer material 8 may be separated efficiently and economically.

The air flow rate, the time period tc (sec) of the gas blowing operation and the timing of starting the gas blowing operation of the transfer material separating air device 20 of the are selected according to one or more of the transfer material delivery conditions.

Referring to FIG. 3, the transfer material front edge detection sensor 26 is turned off as the rear edge of the transfer material 8 passes the transfer material front edge detection sensor 26. When a predefined time period tA (sec) passes after the transfer material front edge detection sensor 26 is turned off and the rear edge of the transfer material 8 passes the center position 25C of the nip section between the two rollers 25a and 25b, the control section stops outputting the gate roller pair drive signal. Then, as a result, the gate roller pair 25 is turned off and stops its rotary motion.

Thus, with the image forming apparatus of the first exemplar arrangement that is provided with the transfer material separating device 19 having the above-described configuration, an air current is generated by the transfer material separating air device 20 and air is blown from the air blowing port 24 toward the separating position 4a so that the transfer material 8 is separated from the intermediate transfer belt 4 by the blown air. Then, as a result, the transfer material 8 is reliably prevented from being moved with the intermediate transfer belt 4 and moved toward the transfer belt conveyor device 27 where the next conveyance station is located.

Since the operating conditions of the transfer material separating air device 20 such as the air flow rate at the time of blowing air, the time period tc (sec) of the air blowing operation and the timing of starting the air blowing operation are defined according to the transfer material delivery conditions of the transfer material 8 that is being delivered from the transfer nip section including the level of difficulty of separation due to the type of the transfer material 8, the white margin (the front non-image part) at the front edge of the transfer material 8 and the moving speed of the transfer material 8, the operation of the transfer material separating air device 20 can be optimized so that the transfer material 8 can be separated highly efficiently and appropriately. Particularly, a transfer material 8 that is separated only with difficulty from the intermediate transfer belt 4 can be separated highly reliably.

Since the operation of the transfer material separating air device 20 can be optimized, the fan can be operated economically to safe energy. Additionally, it may be so arranged that the fan 22 is not driven when no transfer material 8 is conveyed to the secondary transfer device 14 and the gate roller pair 25 is not turned on. Then, as a result, the fan 22 can be operated highly economically to further save energy.

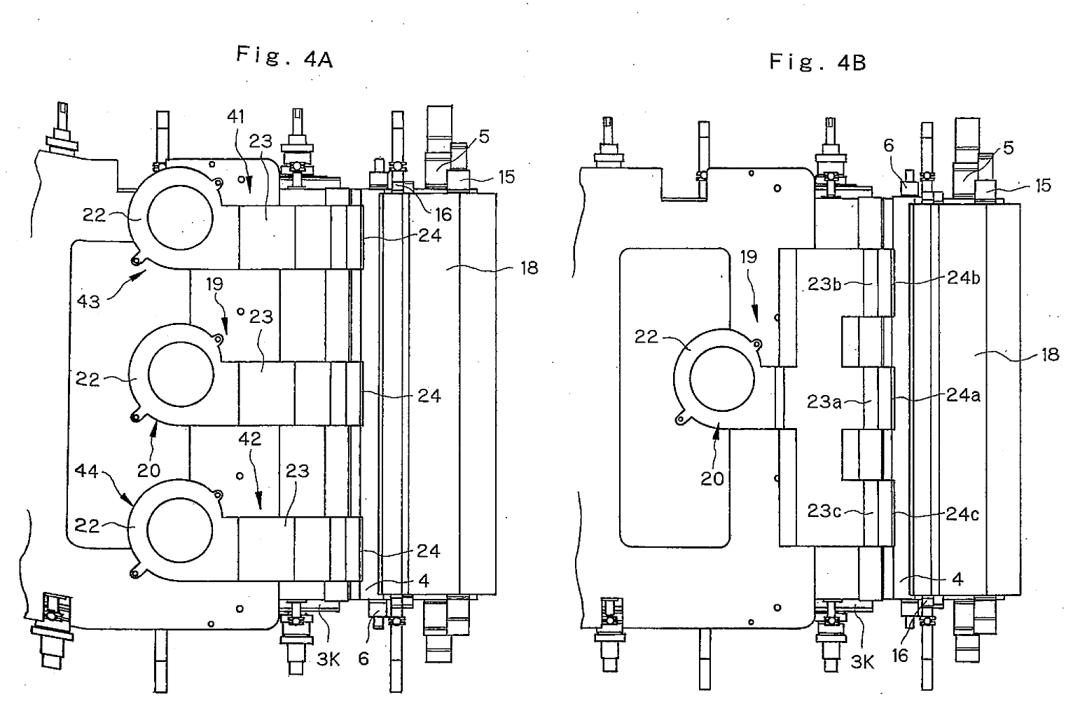

FIG. 4A is a schematic perspective view of a transfer material separating device, showing a second exemplar arrangement, of the embodiment of the present invention. FIG. 4B is a schematic perspective view of a transfer material separating device, showing a third exemplar arrangement, of the embodiment of the present invention.

As shown in FIG. 4A, a second transfer material separating device 41 and a third transfer material separating device 42 are arranged at the opposite sides of the transfer material separating device, which will be referred to as the first transfer material separating device 19 hereinafter, in the image forming apparatus 1 of the second exemplar arrangement. The second and third transfer material separating devices 41 and 42 respectively include second and third transfer material separating air devices 43 and 44 (which correspond to the second and third transfer material separating gas current devices in the appended claims of the present invention) having a configuration exactly same as the first transfer material separating air device 20 of the first transfer material separating device 19 except the flow rate of blown air. In other words, the second and third transfer material separating air devices 43 and 44 have air fans 22, air ducts 23 and air blowing ports 24 respectively. The operation of the second transfer material separating air device 43 and that of the third transfer material separating air device 44 are controlled by the control section of the image forming apparatus 1. The gas currents, or air currents, generated respectively by the fans 22 are made to blow from the air blowing ports 24 toward the separating position 4a of the transfer material 8.

The flow rate of blown air of the second transfer material separating air device 43 and the flow rate of blown air of the third transfer material separating air device 44 are same but lower than the flow rate of blown air of the central first transfer material separating air device 20. In other words, differences are produced in the flow rate of air blown out from the three transfer material separating air devices, or the first through third transfer material separating air devices 20, 43 and 44, as a whole in the direction orthogonal or substantially orthogonal relative to the moving direction of the transfer material such that it is highest at the central part of the front edge of the transfer material 8 that runs in the direction orthogonal or substantially orthogonal relative to the moving direction of the transfer material and lower at the lateral ends of the front edge of the transfer material 8. Thus, a strong wind is made to blow to the central part of the front edge of the transfer material 8 and a weak wind is made to blow to the lateral ends of the front edge of the transfer material 8.

Differences can be produced in the flow rate of blown air by making the number of revolutions per unit time of the air fan 22 of the first transfer material separating air device higher than that of the air fans 22 of each of the other two transfer material separating air devices, or the second and third transfer material separating air devices 43 and 44. Alternatively, differences can be produced in the flow rate of blown air by making the capacity of the air fan 22 of the first transfer material separating air device greater than that of each of the air fans 22 of the other two transfer material separating air devices, or the second and third transfer material separating air devices 43 and 44. Still alternatively, differences can be produced in the flow rate of blown air by making the area of the flow path of the air duct 23 of the first transfer material separating air device 20 smaller than that of the flow path of each of the air ducts 23 of the other two transfer material separating air devices, or the second and third transfer material separating air devices 43 and 44.

With the image forming apparatus 1 of the second exemplar arrangement having the first transfer material separating device 19 having the above-described configuration, an air current is generated from each of the three transfer material separating air devices, or the first through third transfer material separating air devices 20, 43 and 44 and air is blown from the air blowing ports 24 thereof so that the transfer material 8 can be separated reliably by blown air.

Differences are produced in the flow rate of air blown to the front edge of the transfer material 8 in the direction orthogonal or substantially orthogonal relative to the moving direction of the transfer material. Therefore, the transfer material 8 can be efficiently separated from the intermediate transfer belt 4 by producing differences in the flow rate of blown air according to the moving conditions of the transfer material 8 including the level of difficulty of separation due to the type of the transfer material 8, the level of difficulty of separation due to the white margin (the front non-image part) at the front edge of the transfer material 8 and the level of difficulty of separation due to the moving speed of the transfer material 8.

In the image forming apparatus 1 of this second exemplar arrangement, differences are produced in the direction orthogonal or substantially orthogonal relative to the moving direction of the transfer material such that the flow rate of air blown to the front edge of the transfer material 8 is made high at the central part of the transfer material 8 and low at the lateral ends of the transfer material 8 in the direction orthogonal or substantially orthogonal relative to the moving direction of the transfer material. Therefore, the front edge of the transfer material 8 can be reliably separated at the central part thereof so that air can strongly penetrate into the gap between the front edge of the transfer material 8 that is separated at the central part thereof and the intermediate transfer belt 4. Then, since the air that penetrates into the gap at the central part does not practically leak out, the front edge of the transfer material 8 can be effectively separated from the intermediate transfer belt 4 from the central part toward the lateral ends thereof. Particularly, the front edge of the transfer material 8 can be reliably separated if the transfer material 8 is separated only with difficulty from the intermediate transfer belt 4. Thus, the transfer material 8 is prevented from moving with the intermediate transfer belt 4 and hence it can be reliably moved toward the transfer belt conveyor device 27 where the next conveyance station is located.

Furthermore, the flow rate of air blown to the central part of the transfer material 8 and the flow rate of air blown to the lateral ends of the transfer material 8 can be controlled independently by arranging the first through third transfer material separating air devices 20, 43 and 44 at the central part and at each of the lateral ends of the front edge of the transfer material 8 running in the direction orthogonal or substantially orthogonal relative to the moving direction of the transfer material 8. Then, as a result, the transfer material 8 can be appropriately separated from the intermediate transfer belt 4 according to the moving conditions of the transfer material 8.

Otherwise, the image forming apparatus 1 of the second exemplar arrangement is same as the image forming apparatus of the first exemplar arrangement in terms of configuration and advantages.

While three transfer material separating devices, or the first through third transfer material separating devices 19, 41 and 42, are arranged independently in the second exemplar arrangement illustrated in FIG. 4A, only the first transfer material separating device 19 is arranged in the image forming apparatus 1 of the third exemplar arrangement illustrated in FIG. 4B. On the other hand, the first transfer material separating device 19 is provided with the first air duct 23a arranged at a position corresponding to the central part of the transfer material conveyance route and the second and third air ducts 23b and 23c arranged at the opposite lateral ends of the transfer material conveyance route as viewed from the first air duct 23a. Each of the first through third air ducts 23a, 23b and 23c has a configuration same as the above-described duct 23, although the central first air duct 23a is made to show a flow path area smaller than the flow path area of each of the second and third air ducts 23b and 23c at the lateral ends. The flow path area of the second air duct 23b is same as that of the third air duct 23c.

The first through third air ducts 23a, 23b and 23c are connected to a common air fan 22. Therefore, the air flow rate of the central first air duct 23a is higher than the air flow rate of each of the second and third air ducts 23b and 23c arranged at the lateral ends. In other words, air is blown out from the first air blowing port 24a of the central first air duct 23a at a relatively high rate, whereas air is blow out from the second air blowing port 24b of the second air duct 23b and the third air blowing port 24c of the third air duct 23c arranged at the lateral ends at a relatively low rate.

With the third exemplar arrangement, the first through third air ducts 23a, 23b and 23c are arranged at respective positions corresponding to the central part and the left and right lateral ends of the front edges of the transfer material 8 than runs in the direction orthogonal or substantially orthogonal relative to the moving direction of the transfer material 8 and air flow is generated for the first through third air ducts 23a, 23b and 23c by means of a single air fan 22. Thus, the transfer material separating device 19 can be structurally made simple and compact.

Since a single common air fan 22 is provided for the third exemplar arrangement, the capacity of the air fan 22 needs to be larger than each of the three air fans of the second exemplar arrangement.

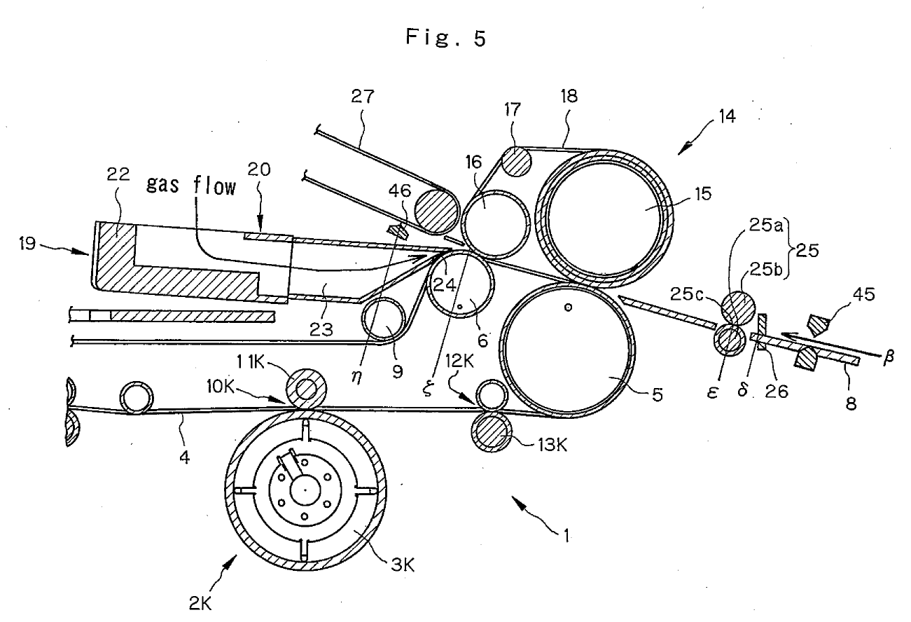

FIG. 5 is an enlarged schematic illustration of part of a transfer material separating device similar to FIG. 2, showing a fourth exemplar arrangement, according to the embodiment of the present invention.

As shown in FIG. 5, in the image forming apparatus 1 of the fourth exemplar arrangement, a transfer material thickness detection sensor 45 is arranged upstream in terms of the moving direction β of the transfer material relative to the transfer material front edge detection sensor 26 and close to the latter. The transfer material thickness detection sensor 45 detects the thickness of the transfer material 8 being conveyed. The transfer material belt conveyor device 27 is provided with a post-transfer transfer material front edge detection sensor 46. Preferably, the post-transfer transfer material front edge detection sensor 46 is arranged at a position where the front edge of the post-transfer transfer material 8 being conveyed is reliably conveyed further on by the transfer material belt conveyor device 27. The post-transfer transfer material front edge detection sensor 46 detects the front edge of the transfer material 8 on which an image is transferred.

Otherwise, the image forming apparatus 1 of the fourth exemplar arrangement is same as the image forming apparatus of the first exemplar arrangement in terms of configuration.

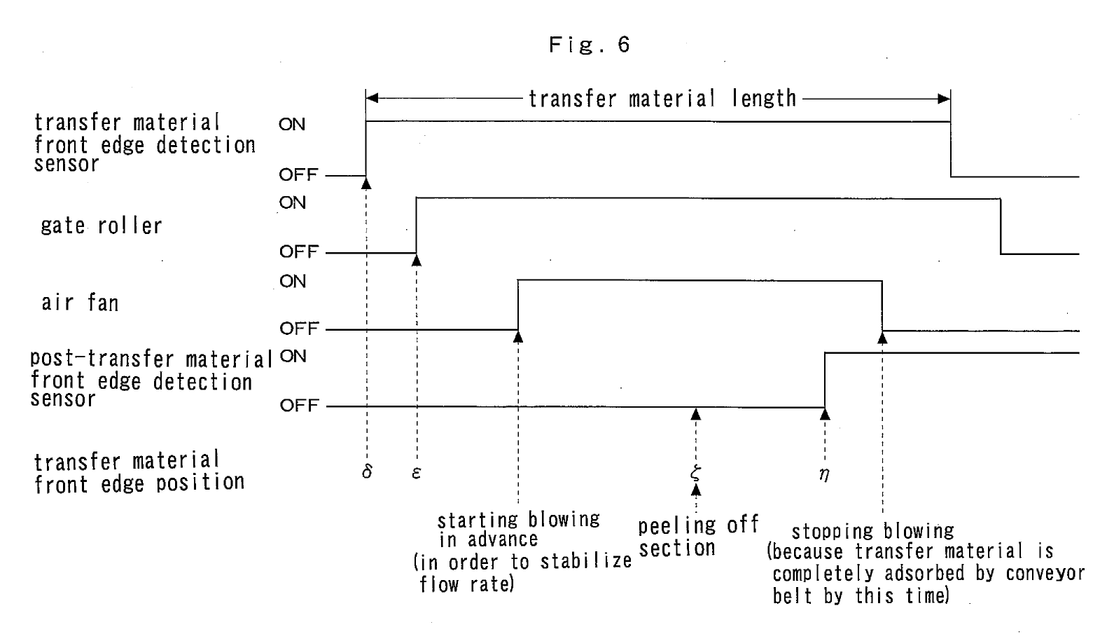

FIG. 6 is a timing chart illustrating the sequence of timings of the air blowing operation of the transfer material separating gas current device of the fourth exemplar arrangement.

As shown in FIG. 6, a pre-transfer transfer material 8 is drive to move toward the secondary transfer device 14 at the transfer material moving speed predefined for the image forming 1 in an image forming operation. As the transfer material 8 passes the transfer material thickness detection sensor 45, the transfer material thickness detection sensor 45 detects the thickness of the transfer material 8.

Subsequently, as the front edge of the transfer material 8 gets to the position δ of the transfer material front edge detection sensor 26, the transfer material front edge detection sensor 26 detects the front edge of the transfer material 8 and becomes on. Additionally, as the front edge of the transfer material 8 gets to the center position 25c of the nip section between the rollers 25a and 25b, the gate roller pair 25 is turned on as described above. Then, the air fan 22 is turned on when a predefined time period tD (sec) passes after the gate roller pair 25 is tuned on. The predefined time period tD (sec) is appropriately so selected that the front edge of the transfer material 8 does not get to the peeling off section ζ for peeling off the transfer material 8 from the intermediate transfer belt 4 before the predefined time period tD (sec) passes. In other words, the air fan 22 is turned on to start blowing air before the front edge of the transfer material 8 gets to the peeling off section ζ because the flow rate of air blown from the air fan 22 is not stabilized immediately after the air fan 22 is turned on. Thus, the flow rate of air blown from the air fan 22 is stabilized and gets to a predetermined desired level at the time when the front edge of the transfer material 8 gets to the peeling off section 4 so that the front edge of the transfer material 8 is effectively peeled off by blown air.

After the transfer material 8 passes the peeling off section ζ and becomes peeled off, it is moved to the transfer material belt conveyor device 27. Then, as the transfer material 8 is adsorbed by the transfer material belt conveyor device 27 and starts moving, the front edge of the transfer material 8 gets to the detecting position η of the post-transfer transfer material front edge detection sensor 46. Thus, the post-transfer transfer material front edge detection sensor 46 is turned on. The air fan 22 is turned off when a predefined time period tE (sec) passes after the post-transfer transfer material front edge detection sensor 46 is turned on. The predefined time period is appropriately so selected as to ensure that the transfer material 8 is completely adsorbed by the transfer material belt conveyor device 27 and the transfer material 8 is reliably conveyed. Then, the air fan 22 stops blowing air.

The transfer material front edge detection sensor 26 is turned off when the rear edge of the transfer material 8 passes it and the gate roller pair 25 is also turned off when the rear edge of the transfer material 8 passes it. Additionally, the post-transfer transfer material front edge detection sensor 46 is also turned off when the rear edge of the transfer material 8 passes it.

With the image forming apparatus 1 of the fourth exemplar arrangement, the air fan 22 is reliably controlled as a function of the position of the transfer material 8 so that the front edge of the transfer material 8 can be efficiently peeled off by blown air. Additionally, the thickness of the transfer material 8 being conveyed is detected by the transfer material thickness detection sensor 45. When the transfer material 8 has a relatively large thickness and hence is firm, the transfer material 8 can be peeled off with ease from the intermediate transfer belt 4 at the peeling off section ζ so that the control section selects a relatively small number of revolutions per unit time and hence a relatively low air flow rate for the air fan 22. When, on the other hand, the transfer material 8 has a relatively small thickness and hence is weak. Transfer material 8 cannot be peeled off with ease from the intermediate 4 at the peeling off section ζ so that the control section selects a relatively large number of revolutions per unit time and hence a relatively high air flow rate for the air fan 22. With this arrangement, the air flow rate can be controlled efficiently according to the thickness of the transfer material 8.

Otherwise, the image forming apparatus 1 of the fourth exemplar arrangement is same as the image forming apparatus of the first exemplar arrangement in terms of configuration and advantages.

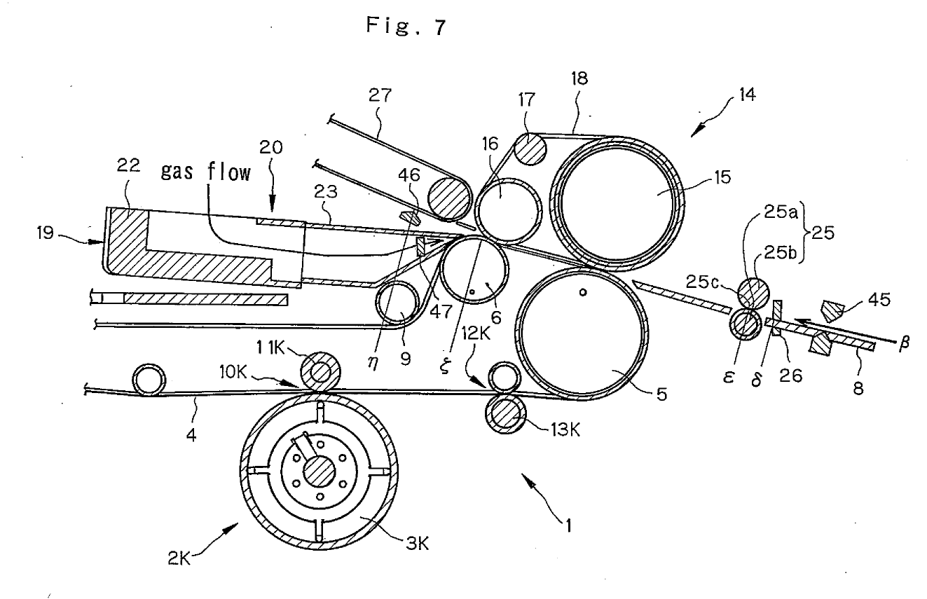

FIG. 7 is an enlarged schematic illustration of part of a transfer material separating device similar to FIG. S, showing a fifth exemplar arrangement, of the embodiment of the present invention.

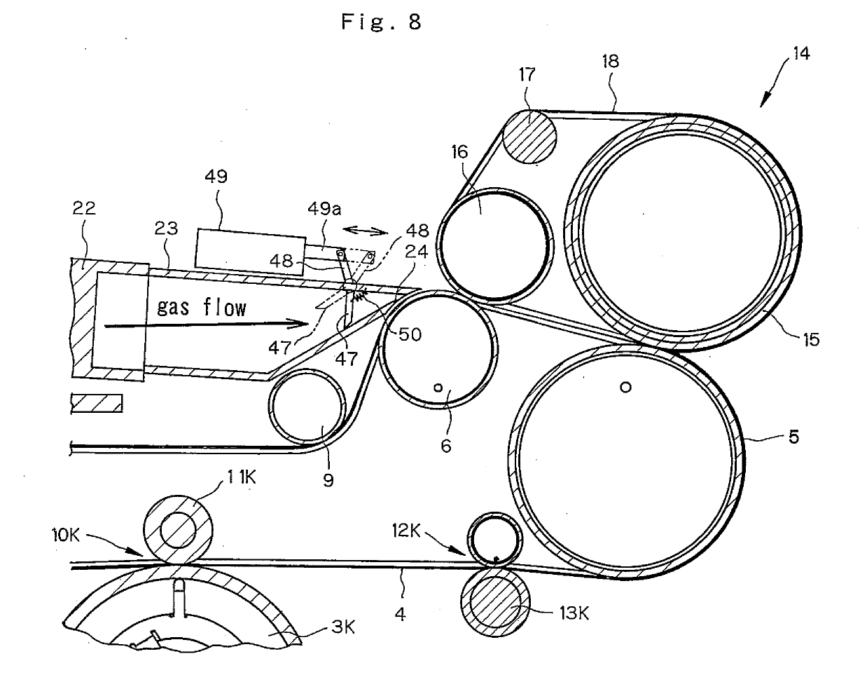

As shown in FIG. 7, in the image forming apparatus 1 of the fifth exemplar arrangement, an air control valve 47, or a gas current control value, is arranged near the air blowing port 24 in the air duct 23. The air control valve 47 controls the operation of opening and closing the air blowing port 24 to control the blown air. As shown in FIG. 8, the air control valve 47 is arranged in the air duct 23 so as to be able to pivot between the closed position of the air blowing port 24 indicated by solid lines and the open position of the air blowing port 24 indicated by double-dotted chain lines.

An actuator lever 48 is integrally linked to the air control valve 47 so as to be able to pivot with the air control valve 47. The actuator lever 48 is linked to the rod 49a of a solenoid 49 so as to be able to rotate relative to each other. The solenoid 49 is excited under the control of the control section. The air control valve 47 is constantly urged toward the closed position of the air blowing port 24 by a return spring 50.

The air control valve 47 is held to the closed position and the air blowing port 24 is closed in an ordinary state where no transfer material 8 is conveyed out of the transfer material containing cassette (not shown). As the air fan 22 is driven to operate, the internal air pressure of the air duct 23 arranged at the side opposite to the air blowing port 24 relative to the air control valve 47 is constantly held to a predetermined level. The predetermined level of air pressure is defined to be such a level that air is blown out stably at a desired flow rate immediately after the air control valve 47 is opened.

As the front edge of the transfer material 8 gets to a position immediately in front of the peeling off section ζ, the solenoid 49 is turned on and the air control valve 47 is put to the open position to open the air blowing port 24. Thus, air in the air duct 23 is blown out from the air blowing port 24 under pressure of a predetermined level. Because the air pressure has already got to the predetermined level at this time, air starts to be blow out stably at a desired flow rate immediately after the air control valve 47 is opened. As a result, the front edge of the transfer material can be peeled off highly reliably and efficiently by blown air.

Otherwise, the image forming apparatus 1 of the fifth exemplar arrangement is same as the image forming apparatus of the fourth exemplar arrangement in terms of configuration.

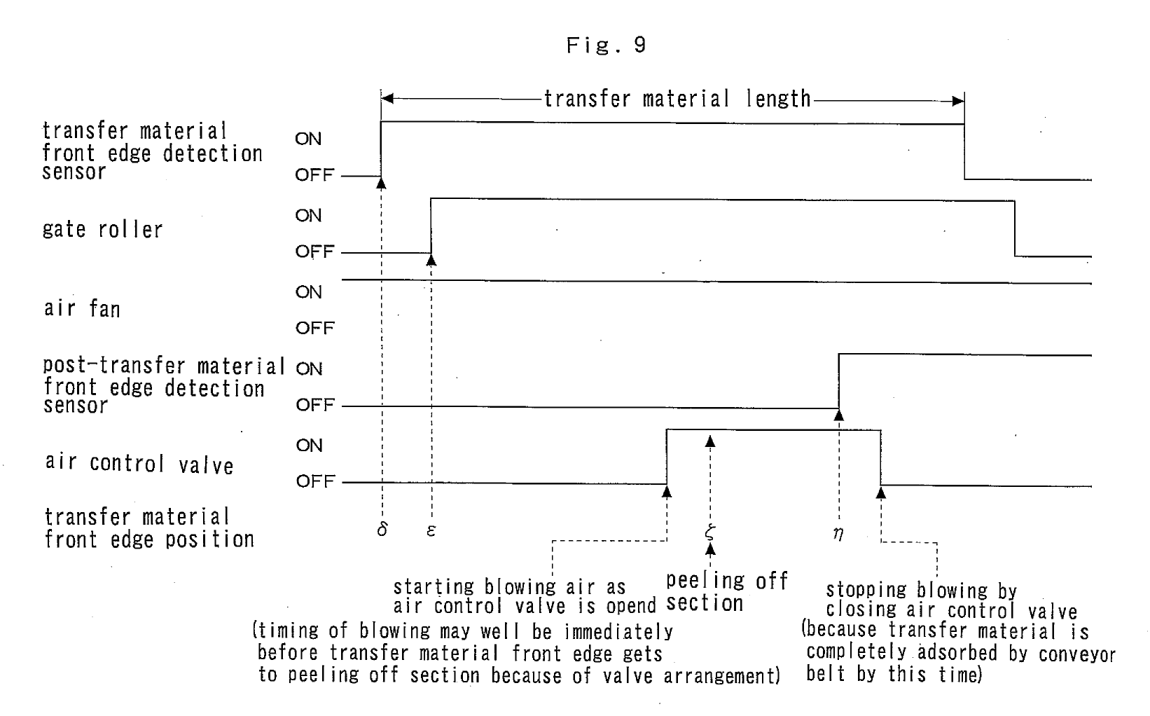

FIG. 9 is a timing chart illustrating the sequence of timings of the air blowing operation of the transfer material separating gas current device of the fifth exemplar arrangement.

As shown in FIG. 9, the sequence of timings of the air blowing operation of the fifth exemplar arrangement differs from that of the fourth exemplar arrangement shown in FIG. 6 only in terms of on/off of the air fan 22 and on/off of the air control valve 47.

The air fan 22 of the fifth exemplar arrangement is held on as long as the internal air pressure of the air duct 23 is held below the predetermined level but turned off when the internal air pressure of the air duct 23 gets to the predetermined pressure level. The control section controls the operation of turning on and off the air fan 22 according to the internal air pressure of the air duct 23 detected by a not-shown pressure sensor. In the illustrated instance, the air fan 22 is held to on-state.

The air control valve 47 is turned on when the front edge of the transfer material gets to a position immediately in front of the peeling off section ζ and set to the open position. This is because air that shows the predetermined level of pressure is blown out by means of the valve so that air is blown out stably at a desired flow rate if the air blowing operation is started when the front edge of the transfer material 8 gets to the position immediately in front of the peeling off section ζ. Thus, the air blowing operation of the air fan 22 can be started lately if compared with the air blowing operation of the fourth exemplar arrangement indicated by double-dotted chain lines in FIG. 9. As a result, the air blowing operation can be started more efficiently under control.

The air control valve 47 is turned off when a predefined time period tF (sec) passes after the post-transfer transfer material front edge detection sensor 46 is turned on. The predefined time period tF (sec) of the air control valve 47 is same as or shorter than the predefined time period tE (sec) of the air fan 22 of the fourth exemplar arrangement. The predefined time period tF (sec) of the air control valve 47 is desirably as short as possible in order to maximally suppress the loss of the internal air pressure of the duct 23.

Otherwise, the image forming apparatus 1 of the fifth exemplar arrangement is same as the image forming apparatus of the fourth exemplar arrangement in terms of configuration and advantages.

The transfer material separating device 19 may be arranged at a position corresponding to the transversal center of the transfer material 8 being conveyed (in the direction orthogonal relative to the direction of conveying the transfer material) or a predetermined number of transfer material separating devices 19 may be arranged transversally relative to the transfer material 8 at regular intervals. When a predetermined number of transfer material separating devices 19 are arranged, the transfer material separating devices 19 are arranged symmetrically relative to the position corresponding to the transversal center of the transfer material 8 from the viewpoint of effectively separating the transfer material 8.

The transfer material separating device 19 may be arranged at a position corresponding to the transversal center of the transfer material 8 being conveyed (in the direction orthogonal relative to the direction of conveying the transfer material) or a predetermined number of transfer material separating devices 19 may be arranged transversally relative to the transfer material 8 at regular intervals. When a predetermined number of transfer material separating devices 19 are arranged, the transfer material separating devices 19 are arranged symmetrically relative to the position corresponding to the transversal center of the transfer material 8 from the viewpoint of effectively separating the transfer material 8.

The present invention may be applied to an image forming apparatus employing liquid developers that does not have any intermediate transfer belt 4 and is adapted to transfer the toner images on the photosensitive bodies 3Y, 3M, 3C and 3K, or the latent image carriers, directly on a transfer material 8. If such is the case, transfer material separating devices are arranged to separate the transfer material from the respective latent image carriers. Then, the latent image carriers respectively include transfer material moving members and liquid developer image carriers of the present invention.

The present invention may also be applied to a 4-cycle image forming apparatus. Furthermore, the present invention may also be applied to an image forming apparatus adapted to use a monochromatic liquid developer.

Furthermore, the operation of a transfer material separating device of the present invention is not limited to separation of the transfer material being delivered from the transfer nip section. A transfer material separating device of the present invention may also be applied to separation of the fixing member (a fixing roller or the like) of the transfer material being delivered from the fixing nip section of the fixing device. If such is the case, the transfer material separating device is arranged downstream relative to the downstream end of the fixing nip section in the transfer material conveying direction.

In short, the present invention can be applied to any transfer material separating device within the scope of the appended claims so long as the transfer material separating device operates for separating a transfer material.

What is claimed is:

1. A transfer material separating device comprising:
a transfer material separating gas current section that separates a transfer material being moved with a transfer material moving member from the transfer material moving member by blowing gas to the transfer material; and
a control section that controls a current of gas being blown from the transfer material separating gas current section to the transfer material;
the transfer material separating gas current section including:
a gas current generating section that generates the current of gas;
a first gas current duct arranged at a position corresponding to a central part of the transfer material in a direction orthogonal or substantially orthogonal relative to a transfer material conveying direction and having a first gas blowing port connected to the gas current generating section;
a second gas current duct arranged adjacent to the first gas current duct in the direction orthogonal or substantially orthogonal relative to the transfer material conveying direction and having a second gas blowing port connected to the gas current generating section; and
a third gas current duct arranged adjacent to the first gas current duct at the side opposite to the second gas current duct in the direction orthogonal or substantially orthogonal relative to the transfer material conveying direction and having a third gas blowing port connected to the gas current generating section.

2. The device according to claim 1, wherein
the gas current generating section includes:
a first gas current generating section that generates a gas current in the first gas current duct;
a second gas current generating section that generates a gas current in the second gas current duct; and
a third gas current generating section that generates a gas current in the third gas current duct.

3. The device according to claim 1, further comprising:
a first gas current control valve arranged at the first gas current duct;
a second gas current control valve arranged at the second gas current duct; and
a third gas current control valve arranged at the third gas current duct.

4. The device according to claim 1, wherein
the control section that controls the gas blown by the transfer material separating gas current section according to a type of the transfer material, a white margin at a front edge of the transfer material and/or a moving speed of the transfer material.

5. The device according to claim 4, wherein
the control section that controls at least a gas flow rate at time of blowing gas by means of the transfer material separating gas current section, a duration of a gas blowing operation or a timing of starting the gas blowing operation.

6. The device according to claim 4, wherein
the control section that controls the transfer material separating gas current section that makes a first flow rate of gas blown from the first gas current duct higher than a second flow rate of gas blown from the second gas current duct and the third flow rate of gas blown from the third gas current duct and additionally makes the second flow rate equal to or substantially equal to the third flow rate.

7. A transfer device comprising:
a transfer section that transfers an image being carried by a developer image carrier onto a transfer material being moved with the developer image carrier;
a transfer material separating section including a gas current generating section that generates a gas current and a transfer material separating gas current section that blows a gas to the transfer material and that separates the transfer material carrying the image transferred from the developer image carrier;
the transfer material separating gas current section including:
a first gas current duct arranged at a position corresponding to a central part of the transfer material in a direction orthogonal or substantially orthogonal relative to a transfer material conveying direction and having a first gas blowing port connected to a gas current generating section;
a second gas current duct arranged adjacent to the first gas current duct in the direction orthogonal or substantially orthogonal relative to the transfer material conveying direction and having a second gas blowing port connected to the gas current generating section; and
a third gas current duct arranged adjacent to the first gas current duct at a side opposite to the second gas current duct in the direction orthogonal or substantially orthogonal relative to the transfer material conveying direction and having a third gas blowing port connected to the gas current generating section.

8. The transfer material separating device according to claim 7, further comprising:
a control section that controls the transfer material separating gas current section that makes a first flow rate of gas blown from the first gas current duct higher than a second flow rate of gas blown from the second gas current duct and a third flow rate of gas blown from the third gas current duct and additionally makes the second flow rate equal to or substantially equal to the third flow rate.

9. An image forming apparatus comprising:
a latent image carrier that carries a latent image;
a developing section that develops the latent image by means of a liquid developer containing toner and a liquid carrier and that forms an image on the latent image carrier;
a transfer member that receives the image developed on the latent image carrier by the developing section;
a transfer section that transfers the image transferred onto the transfer member further onto a transfer material; and
a transfer material separating section that separates the transfer material carrying the image transferred from the transfer member;
a control section that controls the transfer material separating section;
the transfer material separating section including:
a gas current generating section that generates a gas current; and
a transfer material separating gas current section that blows gas to the transfer material;
the transfer material separating gas current section having:
a first gas current duct arranged at a position corresponding to a central part of the transfer material in a direction orthogonal or substantially orthogonal relative to a transfer material conveying direction and having a first gas blowing port connected to the gas current generating section, a second gas current duct arranged adjacent to the first gas current duct in the direction orthogonal or substantially orthogonal relative to the transfer material conveying direction and having a second gas blowing port connected to the gas current generating section and a third gas current duct arranged adjacent to the first gas current duct at a side opposite to the second gas current duct in the direction orthogonal or substantially orthogonal relative to the transfer material conveying direction and having a third gas blowing port connected to the gas current generating section.

10. The apparatus according to claim 9, further comprising:
a transfer material detecting section that detects presence or absence of the transfer material;
a gate roller that conveys the transfer material detected by the transfer material detecting section to the transfer section;
the control section that controls an operation of the transfer material separating gas current section according to a transfer material detection signal from the transfer material detecting section.

11. The apparatus according to claim 9, further comprising:
a gate roller that conveys the transfer material detected by the transfer material detecting section to the transfer section, the gate roller being driven to operate under a control of the control section;
the control section that controls an operation of the transfer material separating gas current section according to a gate roller drive signal that drives the gate roller.

12. The apparatus according to claim 10, further comprising:
a post-transfer transfer material detecting section that detects the transfer material carrying the image transferred from the transfer member by the transfer section;
the control section that controls the operation of the transfer material separating gas current section according to a detection signal from the post-transfer transfer material detecting section.

13. The apparatus according to claim 9, wherein the control section that controls the transfer material separating gas current section that makes a first flow rate of gas blown from the first gas current duct higher than a second flow rate of gas blown from the second gas current duct and a third flow rate of gas blown from the third gas current duct and additionally makes the second flow rate equal to or substantially equal to the third flow rate.
